(19) United States
(12) Patent Application Publication
(10) Pub. No.: US 2005/0101388 A1
(43) Pub. Date: May 12, 2005

(54) Gaming machine

(75) Inventor: Takanori Hattori, Tokyo (JP)

Correspondence Address: SNIDER & ASSOCIATES, P. O. BOX 27613, WASHINGTON, DC, 20038-7613, US

(73) Assignee: Aruze Corporation, Tokyo (JP)

(21) Appl. No.: 10/984,819

(22) Filed: Nov. 10, 2004

(30) Foreign Application Priority Data
Nov. 10, 2003 (JP) 2003-380375

(51) Int. Cl. A63F 13/00

(52) U.S. Cl. 463/46

(57) ABSTRACT

Herein disclosed is a gaming machine which comprises a medal game section for accepting a medal therein, and a medal storage section positioned rearwardly of the medal game section and storing therein a plurality of the medals to be paid out when a jackpot is activated in a game. The gaming machine further comprises a partition member positioned between the medal game section and the medal storage section. The medals stored in the medal storage section can be visually recognized through the partition member.

### CROSS-REFERENCE TO THE RELATED APPLICATIONS

This application is based upon and claims priority from Japanese Patent Application No. 2003-380375, entire contents of which are incorporated herein by reference. This application contains the subject mater related to a co-pending U.S. patent application filed Sep. 24, 2004 by the present inventor and entitled “GAMING MACHINE”, a co-pending U.S. patent application filed by the present inventor, entitled “GAMING MACHINE” and claiming priority from Japanese Patent Application No. 2003-336356, and still a co-pending U.S. patent application filed by the present inventor, entitled “GAMING MACHINE” and claiming priority from Japanese Patent Application No. 2003-380374.

### BACKGROUND OF THE INVENTION

1. Field of the Invention

The present invention relates to a gaming machine which can be installed in a game arcade and the like to allow a player to play a game.

2. Description of the Related Art

There have so far been known various gaming machines such as for example a gaming machine disclosed in the following Patent Publication 1 and another gaming machine disclosed in the following Patent Publication 2. The former game machine is adapted to pay out a large number of game token medals (hereinafter simply referred to as “medals”) stored in a medal storage section thereof when the player's medal dropped into a certain section thereof is detected, while the latter game machine is designed to perform with a medal taken into a hit medal inlet a lottery to determine whether or not a player hits a jackpot and to pay out a certain number of medals in response to the results of the lottery. The conventional game machines thus constructed enables the player to play the game while being excited to expect acquiring a number of medals through the jackpot.

[Patent Publication 1]

Japanese patent laying-open publication No. H10-277256

[Patent Publication 2]

Japanese patent laying-open publication No. 2003-79931

The above conventional gaming machines disclosed in the Patent Publication 1, however, has a drawback that it is extremely difficult for the player to highly raise his or her expectation of hitting the jackpot due to the fact that the medals in the medal storage section are not visible to the player even if a large number of medals are stored in the medal storage section.

The above conventional gaming machines disclosed in the Patent Publication 2, also encounters a problem that it is extremely difficult for the player to visually recognize the total numbers or volume of medals in the medal storage section in spite of the fact that the medals in the medal storage section can be partly watched by the player when the medals are paid out.

It is, therefore, an object of the present invention to provide a gaming machine which can permit the player to watch and visually recognize the total numbers or volume of medals in the medal storage section, and can raise the player's expectation of successfully gaining a large number of medals by hitting the jackpot.

### SUMMARY OF THE INVENTION

According to an aspect of the present invention, there is provided a gaming machine, comprising: a medal game section for accepting a medal therein; a medal storage section positioned rearwardly of the medal game section and storing therein a plurality of the medals to be paid out when a jackpot is activated in a game; and a partition member positioned between the medal game section and the medal storage section, whereby the medals stored in the medal storage section are visually recognized through the partition member.

The medals in the medal storage section are as a whole visible to the player through the partition member, although all of the medals in the medal storage may not be visible to the player in the case that one or more medals are stacked or surrounded by other medals in the medal storage section.

In the gaming machine according to the present invention, the partition member may be made of a transparent material.

The transparent material may desirably be a decorative touch material suitable for not only facilitating to visually recognize the medals in the medal storage section but also adding a decorative touch to the game machine and putting a glaze and fine sight on the medals stored in the medal storage section.

In the gaming machine according to the present invention, the medal storage section may preferably have a thickness slightly larger than that of the medal sufficient to permit the medal to pass therethrough when the medal passes in parallel to the partition member.

The medal storage section having the above specific thickness causes the medals stored in the medal storage section to be brought into contact with one another at their circumferential surfaces and spread in the medal storage section. This results in the fact that all of the medals stored in the medal storage section are visible to the player and the total number of the medals in the medal storage section can be correctly visually recognized by the player.

In the gaming machine according to the present invention, the game may be performed through a lottery to determine whether the jackpot is activated or not when the medal passes through a predetermined area of the medal game section, whereby the medals stored in the medal storage section are paid out when the jackpot is determined to be activated on the basis of the lottery.

In this gaming machine, the lottery for determining whether or not the player hits the jack pot is performed when the deposited medal passes through the predetermined area in the medal game section, and the medals are paid out from the medal storage section based on the result of the lottery. The game progress of the gaming machine is somewhat similar to that of the conventional pachinko(pinball) machine, and thus makes it possible and easy for every player to comfortably smoothly play the game even if the player is the beginner or experienced with the gaming machine.

Further, the result of the game in this gaming machine is not merely relied upon the ability of the player because of the fact that the lottery is performed when the deposited medal successfully passes through the predetermined area in the medal game section and the winning of the jackpot is determined based on the result of the lottery.

Moreover, the gaming machine according to the present invention can be produced so as to allow the player to deposit by hand a medal into the medal game section through a medal insertion slot disposed at the upper portion of the gaming machine in the case that the medal deposited into the medal game section self-falls by its own weight. In this case, the device for feeding or throwing the medal into the medal game section is unnecessary, thereby enabling to reduce the production costs of the gaming machine.

Additionally, the gaming machine according to the present invention may be operative to inform the result of the lottery prior to the payout of the stored medals in order to highly raise the player's expectation of hitting the jackpot.

Incidentally, the medals may be or may include coins, tokens or the like. In other words, the gaming machine according to the present invention may be played with coins, tokens or the like.

### BRIEF DESCRIPTION OF THE DRAWINGS

The features and advantages of a gaming machine according to the present invention will be more clearly understood from the following description taken in conjunction with the accompanying drawings in which:

FIG. 1 is a schematic perspective view showing a preferred embodiment of the gaming machine according to the present invention;

FIG. 2 is an exploded perspective view schematically showing a window panel, a partition member, and a rear panel each forming part of the gaming machine shown in FIG. 1;

FIGS. 3(a) and 3(b) are fragmentary longitudinal cross-sectional views each showing part of the gaming machine shown in FIG. 1;

FIG. 4 is a block diagram schematically showing an interior construction of the game machine shown in FIG. 1;

FIG. 5 is a flowchart showing a game processing routine to be executed by the gaming machine shown in FIG. 1; and

FIG. 6 is a flowchart showing a payout processing routine to be executed by the CPU in the step 20 of the game processing routine shown in FIG. 5.

### DESCRIPTION OF THE PREFERRED EMBODIMENTS

The preferred embodiments of the gaming machine according to the present invention will now be described in detail in accordance with the accompanying drawings.

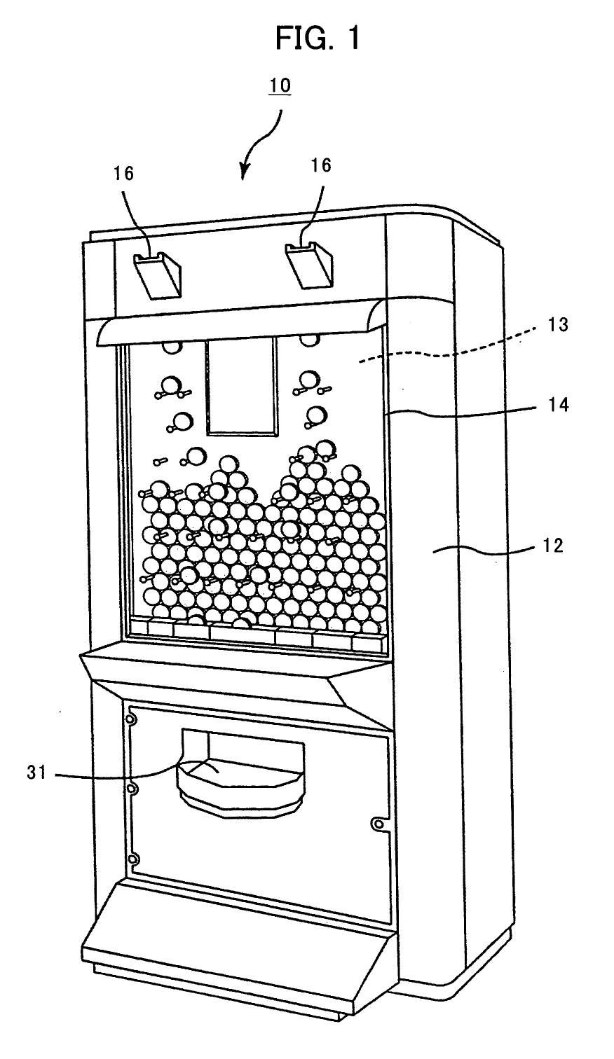

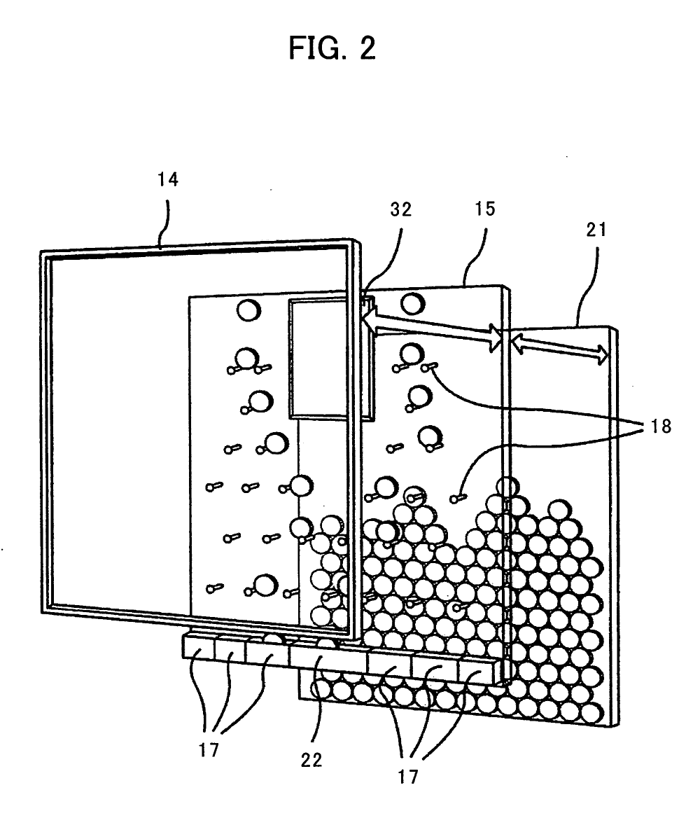

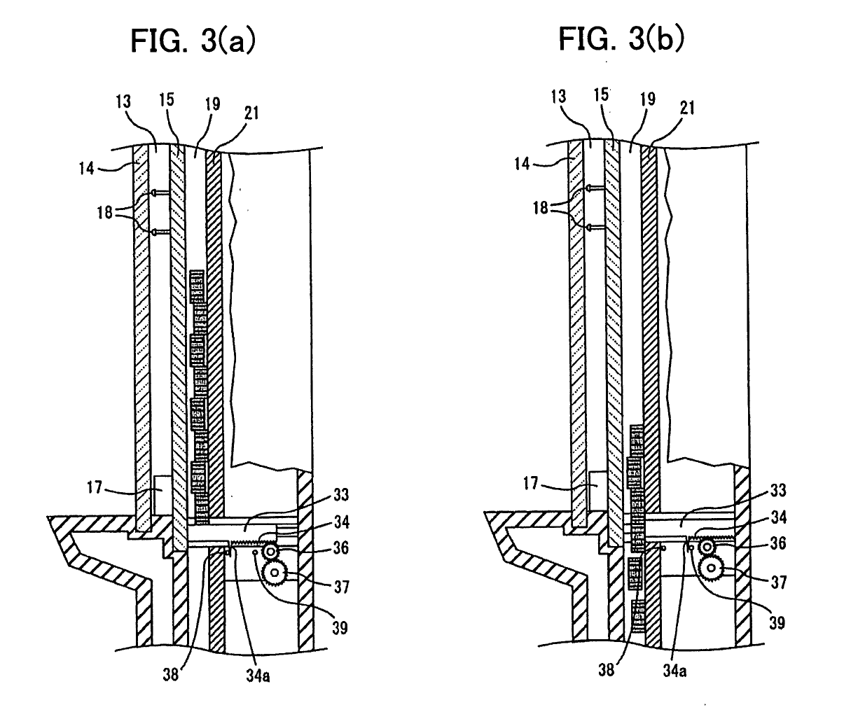

FIG. 1 is a schematic perspective view showing an exemplified gaming machine 10 according to the preferred embodiment. FIG. 2 is an exploded perspective view schematically showing a window panel, a partition member and a rear panel each forming part of the gaming machine shown in FIG. 1. FIGS. 3(a) and 3(b) are respectively fragmentary longitudinal cross-sectional views each showing part of the gaming machine shown in FIG. 1.

The gaming machine 10 comprises a box-shaped housing 12 partially constituted by a window panel 14 made of transparent material to form a medal game space 13 at the rear of the window panel 14, and a medal storage space 19 at the rear of the medal game space 13. The medal game space 13 is partially defined by the window panel 14 to be visible to and seen by a player through the window panel 14.

The medal game space 13 has a medal deposited thereinto by the player and moved therethrough, while the medal storage space 19 has a plurality of medals stored therein behind the medal game space 13. The gaming machine 10 thus comprises a medal game section forming the medal game space 13 and a medal storage section forming the medal storage space 19.

The gaming machine 10 further comprises a partition member 15 made of transparent material such as for example acrylic resin and positioned between the medal game space 13 and the medal storage space 19. The medals stored in the medal storage space 19 can therefore be visually recognized by the player and those around through the window panel 14 and the partition member 15.

Here, the partition member 15 may be made of a semi-transparent material in place of the transparent material according to the present invention.

The gaming machine 10 further comprises a rear panel 21 positioned at the rear of the medal storage space 19. The rear panel 21 may be made of any one of transparent material and semi-transparent material.

The medal storage space 19 has a thickness slightly larger than that of the medal sufficient to permit the medal to pass therethrough in parallel relationship with the window panel 14. Additionally, the medals stored in the medal storage space 19 are spread and laid between the rear panel 21 and the partition member 15 under the condition that the circumferential surfaces of the medals stored in the medal storage space 19 are in contact relationship with one another. The gaming machine 10 further comprises a variable display unit 32 which will be described hereinafter, and a shading member (not shown) disposed at the rear of the display unit 32 within the medal storage space 19. The medal storage space 19 has a portion hidden behind the shading member to prevent the medals from being stored in the hidden portion.

This means the medals stored in the medal storage space 19 can be watched by the player without being hidden behind the shading member to ensure that the player visually recognizes the total volume of the medals in the medal storage space 19.

The gaming machine 10 further comprises a pair of medal dropping devices 16 each disposed above the window panel 14, and a plurality of obstacle members 18 each partly embedded in the partition member 15 to project into the medal game space 13 so that the medals fall down while being hitting with the obstacle members 18 and taken randomly into either of two sets of medal outlets 17 disposed at the bottom of the medal game space 13 or a hit medal inlet 22 disposed between the medal outlets 17. The medal dropping devices 16 are each adapted to allow the player to drop the medal into the medal game space 13 to ensure that the dropped medal is fallen by its own weight in the medal game space 13.

In the rear of the medal dropping devices 16, the housing 12 is formed with a pair of medal slots(not shown) corresponding to the medal dropping devices 16 and their corresponding medal passageways (not shown) extending to the medal game space 13. The width of each of the medal slots is slightly larger than the diameter of the medal. The medal passageways each allows one medal to be passed therethrough and dropped into the medal game space 13 by its own weight. The medal dropping devices 16 are preferably position-adjustable or direction-adjustable and each adjusted by the player to change the position of the medal dropping device 16 or the insertion direction of the medal to be dropped into the medal game space 13.

In the hit medal inlet 22 is provided a medal detecting sensor 28 (not shown) which is constituted by, for example, an infrared optical sensor or the like and adapted to detect the medal in the hit medal inlet 22. When the medal detecting sensor 28 detects the medal dropped into the hit medal inlet 22, the gaming machine 10 performs a lottery in order to decide whether or not to activate a jackpot through a predetermined display game variably displayed on the screen of the display unit 32. The display unit 32 is composed of, for example, a liquid crystal display unit and fitted in the opening formed in the upper portion of the partition member 15. The display unit 32 is adapted to variably display a plurality of combinations of symbols on the screen in a symbol pattern matching game that is similar in contents to the ordinary slot machine. The combinations of symbols are variably partly selected from predetermined plural sets of symbols to display the variably selected symbols on the screen. This symbol pattern matching game is performed by the gaming machine through the steps of starting to change the positions of the symbols each indicative of distinctive information on the screen, stopping the symbols on the screen, determining on whether or not the player wins the jackpot on the basis of the combination of the symbols (for example, “JP”, “JP”, “JP”) fmally stopped on a predetermined playline, and informing the result of the determination to the player.

Here, the medals fallen into each of the medal outlets 17 and the hit medal inlet 22 may be stored in a predetermined storage space formed in the housing 12. The gaming machine 10 may further comprises a medal conveying device for conveying the medals fallen in each of the medal outlet 17 and the hit medal inlet 22 to the medal storage space 19.

As shown in FIG. 3(a), the gaming machine 10 further comprises a medal stopper 33 disposed at the bottom of the medal storage space 19. The medal stopper 33 is adapted to assume two different states consisting of a first state in which the medals are stored in the medal storage space 19, and a second state in which the medals stored in the medal storage space 19 are allowed to be paid out to the player. The medal stopper 33 has a cog portion 34. Below the cog portion 34 of the medal stopper 33, there are provided a driving gear 37 driven by the payout motor 40 (not shown) and a driven gear 36 intervening between the medal stopper 33 and the driving gear 37 in meshing engagement with the cog portion 34 of the medal stopper 33 and the driving gear 37. Furthermore, there are provided a front limit sensor 38 at the back of and in the vicinity of the rear panel 21 and a rear limit sensor 39 rearwardly spaced with respect to the front limit sensor 38 (See FIGS. 3 (a) and 3 (b)). Each of the front limit sensor 38 and the rear limit sensor 39 is exemplified by a mechanical limit switch.

When the medals stored in the medal storage space 19 are paid out to the player as a result of the fact that a jackpot is activated in the lottery, the payout motor 40 is operated to rotate the driving gear 37 in the counterclockwise in FIG. 3 (b) to ensure that the medal stopper 33 is rearwardly moved with respect to the housing 12 (the medal stopper 33 is rightwardly moved with respect to housing 12 in FIGS. 3 (a) and 3(b)). When the medal stopper 33 is rearwardly moved with respect to the housing 12, the medal stopper 33, the partition member 15, and the rear panel 21 collectively form a payout opening between the partition member 15 and the rear panel 21 to ensure that the medals stored in the medal storing space 19 are fallen by their own weight through the payout opening.

Additionally, as shown in FIGS. 3(a) and 3(b), the medal stopper 33 has a projected portion 34a formed with one end of the cog portion 34 to be contactable with each of the front limit sensor 38 and the rear limit sensor 39. When the judgment is made that the projected portion 34a of the medal stopper 33 is brought into contact with the rear limit sensor 39, the payout motor 40 is operated to stop the driving gear 37 in order to stop the medal stopper 33 through the driving gear 37 and the driven gear 36 so as not to be excessively moved with respect to the housing 12. After the driving gear 37 is stopped over a predetermined period of time (for example, 5[sec]), the payout motor 40 is operated to reversely rotate the driving gear 37 to ensure that the medal stopper 33 is forwardly moved with respect to the housing 12 (the medal stopper 33 is leftwardly moved with respect to the housing 12 in FIG. 3 (a) or 3(b)).

When the medal stopper 33 is forwardly moved with respect to the housing 12, the projected portion 34a of the medal stopper 33 is brought into contact with the front limit sensor 38. When the judgment is made that the projected portion 34a of the medal stopper 33 is brought into contact with the front limit sensor 38, the payout motor 40 is operated to stop the driving gear 37. While the medal stopper 33 is stopped to have the payout opening retained to be opened, all of the medals stored in the medal storage space 19 are fallen by their own weight through the payout opening into the medal outlet 31 so as to be paid out to the player.

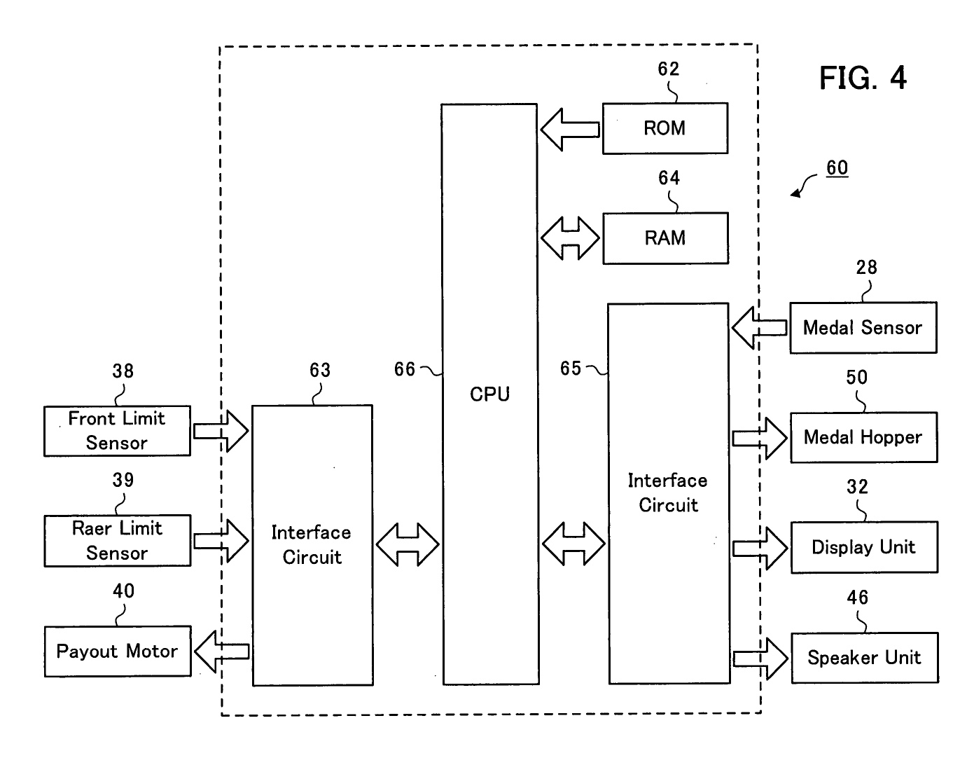

The gaming machine 10 further comprises a medal hopper 50 (not shown in FIGS. 1 to 3; see FIG. 4) disposed at the top of the rear panel 21 to refill the medal storage space 19 with medals when the medals previously stored in the medal storage space 19 are paid out to the player as a result of the fact that the player hits the jackpot. Additionally, the partition member 15, the rear panel 21, and the display unit 32 collectively define right and left medal paths having passed therethrough the medals to be stored in the medal storage space 19 by the medal hopper 50. This leads to the fact that the right and left medal paths collectively make it possible to allow the medal hopper 50 to evenly store the medals in the medal storage space 19.

FIG. 4 is a block diagram schematically showing the interior of the gaming machine according to the preferred embodiment. As shown in FIG. 4, the gaming machine 10 further comprises a controlling section 60 to be accommodated in the housing 12. The controlling section 60 includes a central processing unit (hereinafter simply referred to as “CPU”) 66, ROM 62, RAM 64, and other elements.

The ROM 62 has stored therein a game program which allows the CPU 66 to totally control the gaming machine 10 to perform a game, a lottery program which allows the CPU 66 to perform a lottery to decide whether or not to activate a jackpot, sound data which allow the CPU 66 to produce a back ground music and other sound effects depending on the game, and a probability table. The lottery is performed by using the probability table stored in the ROM 62 to ensure that determination is made by the CPU 66 on whether or not to allow the player to hit jackpot.

The CPU 66 is electrically connected to each of the frond limit sensor 38, the rear limit sensor 39, and the payout motor 40 through an interface circuit 63. When the resultant information of the jackpot is displayed by the display unit 32 as a result of the decision that the player hits the jackpot, the CPU 66 is operated to produce a first driving signal to be supplied to the payout motor 40 in order to drive the payout motor 40 and rearwardly move the medal stopper 33. When the rear limit sensor 39 detects the medal stopper 33 and produces a predetermined medal detection signal to be received by the CPU 66, the CPU 66 is operated to produce a stop signal to stop the payout motor 40 for a predetermined period of time (for example, 5 [sec]). The CPU 66 is then operated to produce a second drive signal to be supplied to the payout motor 40 for ensuring that the driving shaft of the payout motor 40 is reversely rotated to forwardly move the medal stopper 33. When the front limit sensor 38 detects the medal stopper 33 moved in the forward direction and produces a medal detection signal to be received by the CPU 66, the CPU 66 is operated to produce a stop signal to be supplied to the payout motor 40 and stop the payout motor 40.

The CPU 66 is electrically connected to each of the medal sensor 28, the medal hopper 50, the display unit 32, and the speaker unit 46 through the interface circuit 65. The medal sensor 28 is adapted to detect the medal dropped into the hit medal inlet 22, while the medal hopper 50 is adapted to replenish the medal storage space 19 with medals when the medals previously stored in the medal storage space 19 are paid out to the player with the jackpot. The display unit 32 is adapted to display on the screen the variable display game, for example, the symbol pattern matching game, while the speaker unit 46 is adapted to output a sound such as for example background music, a voice, other effective sound and so on.

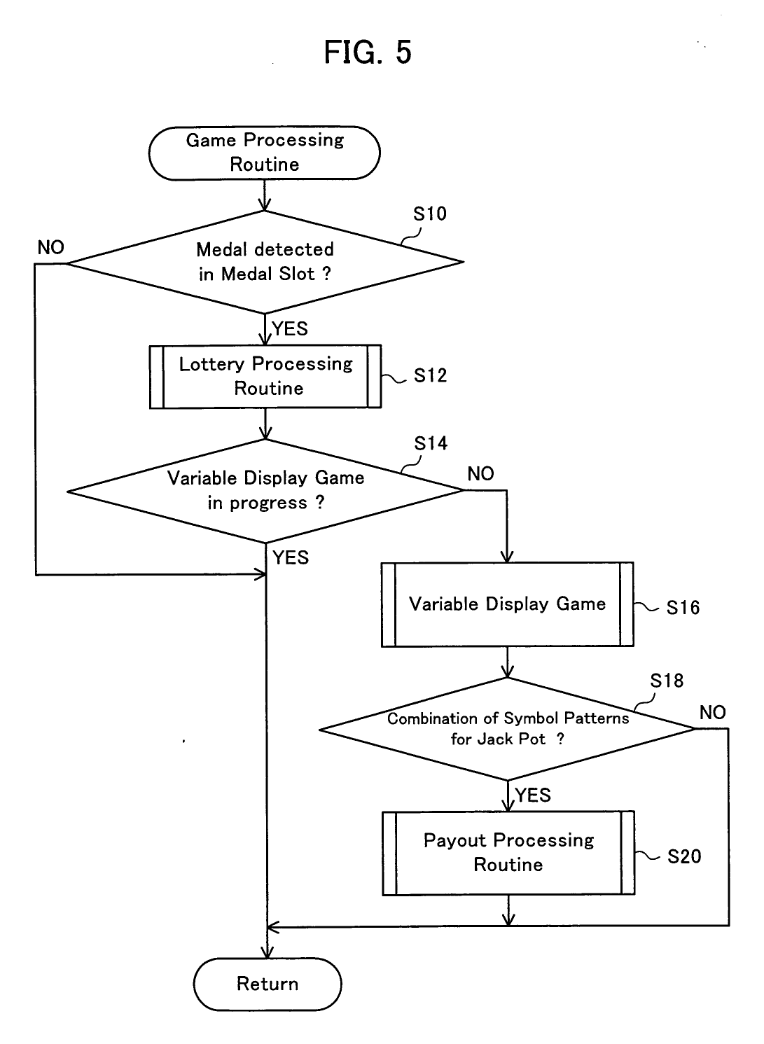

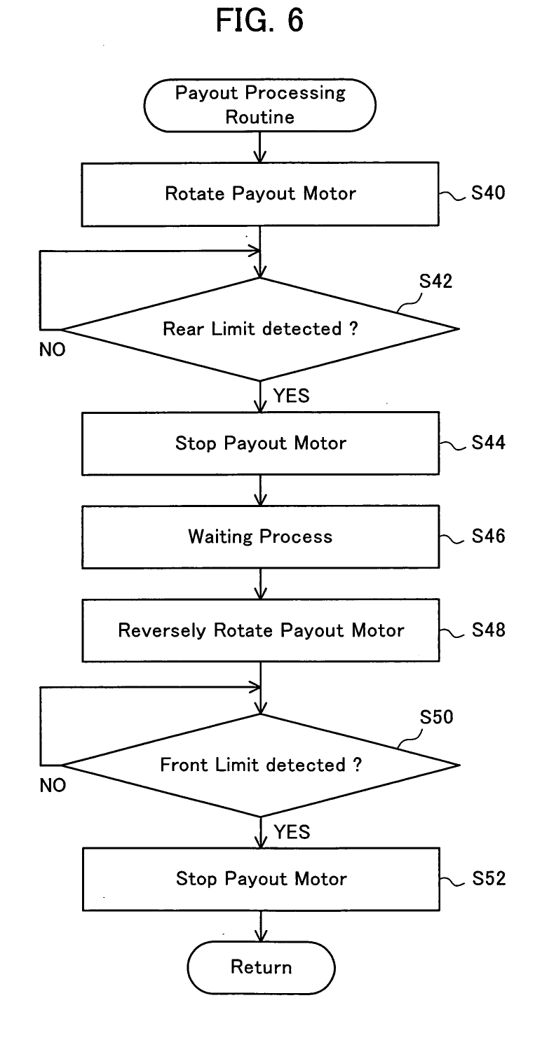

The operation of the gaming machine according to the preferred embodiment will be described hereinafter with reference to FIGS. 5 and 6. FIG. 5 is a flowchart showing a game processing routine to be repeatedly executed by the gaming machine 10 shown in FIG. 1.

The CPU 66 is firstly operated to determine on whether or not the medal is dropped into the hit medal inlet 22 in the step S10. More specifically, the judgment is made by the CPU 66 on whether or not the medal dropped into the hit medal inlet 22 is detected by the medal sensor 28. When the result of the judgment in the step S10 is in the negative “NO”, i.e., the medal is not dropped into the hit medal inlet 22, the routine process operation proceeds to the end of the game processing routine from the step S10.

When, on the other hand, the result of the judgment in the step S10 is in the affirmative “YES”, i.e., the medal is dropped into the hit medal inlet 22, the routine process operation proceeds to the step S12 from the step S10. The lottery processing routine is then executed by the CPU 66 in the step S12. More specifically, the CPU 66 is operated to perform the lottery by using the above-mentioned probability table to determine on whether or not to activate a jackpot. The result of the lottery is then stored as lottery data in the RAM 64.

Next to the step S12, the judgment is made by the CPU 66 on whether or not the variable display game e.g. a symbol pattern matching game is in progress and being played by the player in the step S14. The condition where the variable display game is in progress corresponds to the operation condition under which the combinations of the above-mentioned symbols displayed on the screen are being changed. After this condition, the combinations of symbols are brought to standstill on the screen, in other words, fixedly displayed

When the result of the judgment in the step 14 is in the affirmative “YES”, i.e., the symbol pattern matching game is being performed, the routine process operation proceeds to the end of the lottery processing routine.

When, on the other hand, the result of the judgment in the step 14 is in the negative “NO”, i.e., the symbol pattern matching game is not being performed, the routine process operation proceeds to the step S16 from the step S14. The variable display game, e.g., a symbol pattern matching game is then executed in the step S16. In this routine, the combination of the symbols each representing distinctive information are firstly changed and lastly halted on the screen of the display unit 32. When the player hits the jackpot on the basis of the lottery, a certain combination of symbols (for example, “JP”, “JP”, and “JP”) selected from the plural sets of symbols are displayed on the screen to collectively indicate the jackpot.

The judgment is then made on whether or not the certain combination of symbols are fixedly displayed on the screen in the step S18. When the result of the judgment in the step S18 is in the negative “NO”, in other words, the combination of the symbols fixedly displayed on the screen is not indicative of the jackpot, the routine process operation proceeds to the end of the symbol pattern matching game processing routine. Additionally, the medals stored in the medal storage space 19 are not paid out to the player.

When, on the other hand, the result of the judgment in the step S18 is in the affirmative “YES”, i.e., the combination of the symbols displayed on the screen is indicative of the jackpot, the routine process operation proceeds to the step S20. The CPU 66 is then operated to pay out the medals stored in the medal storage space 19 to the player in the step S20. More specifically, the CPU 66 is operated to open and close the medal stopper 33 to ensure that the medals stored in the medal storage space 19 are paid out to the player by producing the driving signals to be supplied to the payout motor 40 to drive the payout motor 40, and by producing the stopping signal to be supplied to the payout motor 40 to stop driving the payout motor 40. After the step 20, the routine process operation proceeds to the end of the game processing routine.

FIG. 6 shows the payout processing routine to be executed by the CPU 66 in the step 20 of the game processing routine. The CPU 66 is firstly operated to produce a driving signal which is supplied to the payout motor 40 to open the medal stopper 33 in the step S40. More specifically, the driving shaft of the payout motor 40 is rotated in the counterclockwise (see FIG. 3(b)) with respect to the housing 12 when the medal stopper 33 is rearwardly moved with respect to the housing 12.

The CPU 66 is then operated to check on whether or not the detection signal is received from the rear limit sensor 39 in the step S42. The detection signal is produced by the rear limit sensor 39 as a result of the fact that the contact point 34a of the cog potion 34 of the medal stopper 33 is detected by the rear limit sensor 39 while the medal stopper 33 is being rightwardly moved with respect to the housing 12 (see FIG. 3 (a)). When the result of the judgment in the step S42 is in the negative “No”, i.e., the detection signal is not received from the rear limit sensor 39, the routine process operation does not proceed to the step 44. In other words, the judgment is repeatedly made by the CPU 66 on whether or not the detection signal is received from the rear limit sensor 39 until the detection signal is received from the rear limit sensor 39.

When, on the other hand, the result of the judgment in the step S42 is in the affirmative “YES”, i.e., the detection signal is received from the rear limit sensor 39, the routine process operation proceeds to the step 44. The CPU 66 is then operated to produce the stop signal to be supplied to the payout motor 40 in order to stop driving the payout motor 40 in the step S44.

The CPU 66 is then operated to have the medal stopper 33 opened over the predetermined period (5 [sec]) in the step S46. The payout motor 40 is then operated to have the driving gear 37 reversely rotated to ensure that the medal stopper 33 is forwardly moved with respect to the housing 12 as shown in FIG. 3(a).

The CPU 66 is then operated to determine whether or not the detection signal is received from the front limit sensor 38 in the step S50. More specifically, the judgment is made by the CPU 66 on whether or not the contact point 34a of the cog potion 34 of the medal stopper 33 is detected by the front limit sensor 38 when the medal stopper 33 is being forwardly moved with respect to the housing 12. When the result of the judgment in the step S42 is in the negative “No”, i.e., the detection signal is not received from the front limit sensor 38, the routine process operation does not proceed to the step 52. In other words, the judgment is repeatedly made by the CPU 66 on whether or not the detection signal is received from the front limit sensor 38.

When, on the other hand, the result of the judgment in the step S50 is in the affirmative “YES”, i.e., the detection signal is received from the front limit sensor 38, the routine process operation proceeds to the step 52. The CPU 66 is finally operated to produce the stop signal to be supplied to the payout motor 40 in order to stop driving the payout motor 40 in the step S52. After the step S52, the routine process operation proceeds to the end of the payout processing routine.

From the above detailed description and FIGS. 5 and 6, it will be understood that the gaming machine 10 according to the preferred embodiment can pay out the medals fallen from the medal storage space 19 to the player by opening the medal stopper 33 over the predetermined period (5 [sec]) when the player wins the lottery which is performed in order to determine whether or not to allow the player to hit the jackpot.

From the above detailed description and FIGS. 1 to 6, it will be understood that the gaming machine 10 according to the preferred embodiment can allow the medals stored in the medal storage space 19 to be easily watched and visually recognized in total volume by the player through the partition member 15 by the reason that the partition member 15 positioned between the medal game space 13 and the medal storage space 19 is made of transparent material, and that the medal storage space 19 has a thickness slightly larger than that of the medal to permit the medal to pass therethrough under the condition that the medal is in parallel relationship with the partition member 15. Accordingly, the player can operate the gaming machine 10 in the expectation of gaining the medals with the jackpot by watching and recognizing the total volume of the medals stored in the medal storage space 19. The gaming machine 10 according to the preferred embodiment can be additionally put thereto a decorative touch by the partition member 15.

Additionally, the gaming machine 10 according to the preferred embodiment can allow the player to easily recognize the flow of the game, and to play the game in the anticipation of hitting the jackpot by wining the lottery as well as a well-known pachinko(pinball) machine by the reason that the gaming machine 10 is adapted to perform the game through the lottery to determine whether or not to activate the jackpot when the deposited medal is being fallen by its own weight and passes through the hit medal inlet 22 that is a predetermined area of the medal game space, whereby the medals stored in the medal storage space are paid out to the player when the jackpot is determined to be hit by the player on the basis of the result of the lottery.

The gaming machine 10 according to the preferred embodiment can perform the game through the steps of performing the lottery as a result of the fact that the medal is dropped into the medal game space 13 to be fallen by its own weight in the hit medal inlet 22, determining whether or not to activate the jackpot when the player wins the lottery, performing the variable display game by which the player's expectation is raised, and paying out the medals stored in the medal storage space to the player when the jackpot is activated. Accordingly, the result of the game in this gaming machine is not merely relied upon the ability of the player, and every player can comfortably play and enjoy the game even if the player is the beginner or well aware of the gaming machine.

The gaming machine 10 according to the preferred embodiment can be produced at a relatively low cost by the reason that the gaming machine 10 comprises a housing 12 formed with a medal game space 13 which is simple in construction, and a pair of medal dropping devices 16 each of which is simple in construction to be positioned on the upper side of the housing 12 to ensure that the medal dropped by the player is fallen by its own weight in the medal game space 13.

While there has been described in the forgoing embodiment that the partition member of the gaming machine is made of a transparent material such as for example acrylic resin to ensure that the medals stored in the medal storage space are visible to the player through the partition member, the partition member may be constituted by a meshed opaque material or the like which allows all of the medals in the medal storage space to be substantially visible to the player.

While there has been described in the forgoing embodiment about the fact that the medal storage section has a thickness of the medal storage space slightly larger than that of the medal to permit the medal to pass therethrough under the condition that the medal is in parallel relationship with the partition member, the thickness of the medal storage space may be large sufficient to permit two or more medals pass therethrough under the condition that the total volume or amount of the medals stored in the medal storage section can be visually recognized by the player through the partition member.

In this case, two or more medals can be stacked in the medal storage section under the condition that each of the medals is in parallel relationship with the partition member, or two or more medals are stacked and piled up in the medal storage section under the condition that each of the medals is in perpendicular relationship with the partition member, and the gaming machine can allow the player to watch overall of the medal storage section to recognize the total numbers or volume of the medals stored in the medal storage section.

While there has been described in the forgoing embodiment about the fact that the gaming machine is adapted to permit the dropped medal to be fallen by its own weight in the medal game section, the dropped medal may be slidably moved with respect to the partition member. In this case, the partition member may be slanted with respect to the aforementioned vertical partition member. The medal dropped into the medal game section may be moved in a horizontal direction in the medal game section. The gaming machine may further comprise a medal shooter for injecting a medal to be moved in the medal game section.

While there has been described in the forgoing embodiment about the fact that the gaming machine is adapted to allow the player to usually watch the medals stored in the medal storage section through the partition member made of transparent material, the gaming machine may further comprise a liquid crystal shutter positioned at for example the rear of the partition member to assume two different states consisting of a transparent state to permit the medals stored in the medal storage section to be visible to the player when the player reaches a predetermined game condition by playing the game, and an opaque state not to permit the medals stored in the medal storage section to be visible to the player while the player fails to reach the predetermined game condition by playing the game.

While there has been described in the forgoing embodiment about the fact that the medals stored in the medal storage section are paid out to the player as a result of the fact that the player hits the jackpot after the gaming machine is operated to perform the lottery to determine whether or not to activate the jackpot, the gaming machine may be designed to permit the jackpot to be activated without performing the lottery when the dropped medal is fallen through a predetermined area of the medal game section, or when the dropped medal is touched with one or more targets positioned in the medal game section.

1. A gaming machine, comprising:
a medal game section for accepting a medal therein;
a medal storage section positioned rearwardly of said medal game section and storing therein a plurality of the medals to be paid out when a jackpot is activated in a game; and
a partition member positioned between said medal game section and said medal storage section, whereby said medals stored in said medal storage section are visually recognized through said partition member.

2. A gaming machine as set forth in claim 1, in which said partition member is made of a transparent material.

3. A gaming machine as set forth in claim 1, in which said medal storage section has a thickness slightly larger than that of said medal sufficient to permit the medal to pass therethrough when said medal passes in parallel to said partition member.

4. A gaming machine as set forth in claim 1, in which said game is performed through a lottery to determine whether said jackpot is activated or not when said medal passes through a predetermined area of said medal game section, whereby said medals stored in said medal storage section are paid out when said jackpot is determined to be activated on the basis of said lottery.
